(19) United States
(12) Patent Application Publication
(10) Pub. No.: US 2024/0043629 A1
(43) Pub. Date: Feb. 8, 2024

(54) ELASTOMERIC BIOMATERIALS AND THEIR MANUFACTURE

(71) Applicant: RESELO AB, Halmstad (SE)

(72) Inventors: Thomas BAUMGARTEN, SOLNA (SE); Lauren Sara MCKEE, BROMMA (SE)

(21) Appl. No.: 18/257,041

(22) PCT Filed: Dec. 13, 2021
(86) PCT No.: PCT/SE2021/051244

§ 371 Date: Jun. 12, 2023

(30) Foreign Application Priority Data
Dec. 14, 2020 (SE) 2030361-6

(51) Int. Cl. C08H 8/00; C08J 11/16; C08L 97/00; C08L 99/00

(52) U.S. Cl. CPC C08H 8/00; C08J 11/16; C08L 97/00; C08L 99/00

(57) ABSTRACT

The invention relates to an elastomeric material and its method of manufacture, comprising the consecutive steps of a) providing powdered birch bark; b) removing extractives to obtain a fraction comprising suberin; c) alkaline hydrolysis of the fraction comprising suberin, whereby suberin is broken down to suberin monomers; d) acidification of the fraction comprising suberin monomers, whereby the subein monomers are protonated; e) extraction of the suberin monomers, whereby the protonated suberin monomers are separated from hydrophilic compounds; f) melting the suberin monomers; and g) polymerizing the melted monomers, wherein no added catalyst is present during the polymerization, and wherein a cross-linked elastomer is obtained.

### FIELD OF INVENTION

The invention relates to the field of bio-based plastics, and in particular to a cross-linked elastomeric material and its manufacture.

### BACKGROUND

As we move away from our dependence on fossil resources, and towards a circular bio-economy, demand for sustainably produced bio-based materials is ever increasing. However, since the production of traditional bio-based materials, like natural rubber, is not sufficient to satisfy the demand for such materials, alternative feedstocks are needed for the development of biomaterials.

Betula pendula (silver birch tree) is one of the most important hard wood species in Northern Europe, mainly due to its extensive use in the pulp and paper industry. Birch bark must be removed from the wood prior to processing, and so it is an abundant residue of this industry. Indeed, a single paper mill can produce approximately 28,000 tons of birch bark per year. To date, birch bark has been regarded as a low-value residue that is mainly used for energy generation in the pulp and paper industry. However, birch bark contains high amounts of various valuable compounds such as betulin/betulinic acid and suberin, making birch bark an ideal candidate for developing sustainable polymers. In particular, suberin is a great feedstock to develop bio-based materials, due to its high content of aliphatic compounds that can confer important physical and bio-active attributes to the polymers produced.

In the plant, suberin comprises a network of long chain fatty acids, aromatic compounds and glycerol. Notably, besides the abundant carboxylic acid groups, the long chain fatty acids in suberin often have additional functional groups, making them attractive building blocks to develop novel polymers.

There already exist methods for producing polymers based on suberin monomers. However, there are a number of shortcomings with the present methods. For one, they cannot provide crosslinked suberin-based polymers. De Oliveira, Hugo, et al., “All natural cork composites with suberin-based polyester and lignocellulosic residue,” in Industrial Crops and Products, 109 (2017): 843-849, indeed discloses only such non-crosslinked elastomeric materials. Moreover, the required processing steps and additives needed commonly increase the cost of production. Hence, there is a need for improved elastomeric materials based on suberin monomers, and for improved methods of polymerizing suberin monomers.

### SHORT DESCRIPTION OF THE INVENTION

In accordance with the invention, there is provided an elastomeric material obtainable using a biorefinery approach that is based on mild conditions, such as reaction temperatures below 100° C. as well as usage of diluted acids/bases, and non-toxic, biodegradable solvents to isolate valuable components from birch bark. This process yields three fractions: a betulin rich fraction, a lignin-carbohydrate enriched fraction, and a fraction of suberin monomers (see FIG. 1).

The elastomeric material of the invention is obtainable using a method of polymerizing suberin monomers, comprising the consecutive steps of
a) providing powdered birch bark;
b) removing extractives to obtain a fraction comprising suberin;
c) alkaline hydrolysis of the fraction comprising suberin, whereby suberin is broken down to suberin monomers;
d) acidification of the fraction comprising suberin monomers, whereby the suberin monomers are protonated;
e) extraction of the suberin monomers, whereby the protonated suberin monomers are separated from hydrophilic compounds;
f) melting the suberin monomers; and
g) polymerizing the melted monomers,
   wherein no added catalyst is present during the polymerization, and wherein the elastomeric material obtained is cross-linked.

Benefits of the elastomer obtainable by the method is that it is not derived from fossil fuels and in contrast to natural rubber, the feedstock used in accordance with the invention does not compete with agricultural resources, nor uses resources from tropical rain forest.

Previously, enzymes like the lipase Novozyme 435 have been used to polymerize epoxidized suberin monomers in toluene. Since such enzymes can catalyze specifically the reaction of terminal hydroxyl groups with carboxylic acid groups this process will result in the formation of linear polymer chains with an intact epoxy group. However, such approach requires the separation of the enzyme and the polymer, thus making process more complex and materials obtained by such processes are rather brittle. In contrast, in accordance with the inventive method, only benign solvents are used and no additional catalyst is necessary, thus making the method environmentally favorable. Moreover, whereas an enzymatic polymerization results in the formation of linear polymers, the polymerization conditions used in accordance with the invention allow the formation of ester bonds between all available hydroxyl and carboxyl groups. Hence, the inventive elastomeric material consists of a network-like structure of suberin monomers. Characterization of the suberin-based elastomer shows a hydrophobic material that is stable under acidic and alkaline conditions and insoluble in common organic solvents.

The invention shall now be described with reference to the accompanying Figures, which shall however not be seen as limiting the scope of protection in any way whatsoever. The skilled person realizes that modifications may be made, which would be within the scope of protection.

### SHORT DESCRIPTION OF THE FIGURES

FIG. 1 depicts the provision of suberin monomers, in accordance with the invention.

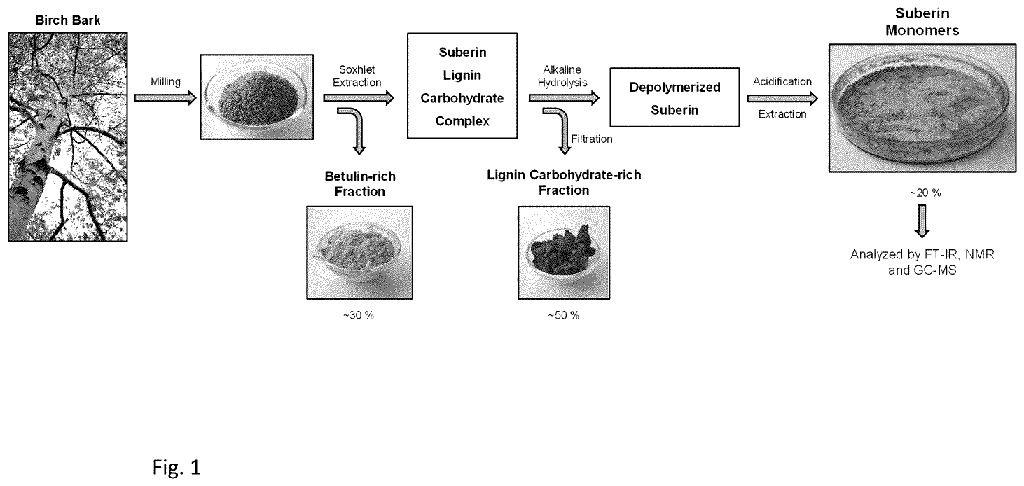

FIG. 2 shows the characterization of isolated suberin monomers provided in accordance with the invention. An FT-IR spectrum of isolated suberin monomers. The region between 3600-3100 cm⁻¹ was assigned to OH vibration. The peaks around 3000-2800 cm⁻¹ were assigned to CH vibration and the peak at 1700 cm⁻¹ represents vibration of COOH groups. B NMR spectrum of isolated suberin monomers. Chemical shifts at 3.65 ppm were assigned to the protons adjacent to an OH group and chemical shifts at 2.35 ppm were designated to protons adjacent to a COOH group.

FIG. 3 relates to the method of polymerizing suberin monomers. A fully bio-based material was synthesized from isolated suberin monomers by melt processing. (A) The ratio of COOH groups to OH groups, present in isolated suberin monomers, was calculated from NMR data (see FIG. 2). (B) DSC melting curve of isolated suberin monomers. (C) Proposed reaction scheme of the formation of the suberin-based elastomer. If reaction takes place in an open system and above 100° C., the water that forms during the reaction evaporates immediately. (D) Images of the produced elastomer. The high flexibility of the material is demonstrated by first bending it extensively and then allowing the material to relax into its former state. (E) FT-IR spectrum of the produced elastomer. The region between 3600-3100 cm¹ was assigned to OH vibration and the peak at 1733 cm⁻¹ represents the COOR vibration. For comparison, the spectrum of the isolated suberin monomers is shown.

FIG. 4 shows the mechanical properties of the suberin-based elastomer according to the invention. Rectangular specimen of the inventive elastomer were prepared. Averages and standard deviations were calculated based on data derived from individually produced material. (A) Tensile test. Stress strain curves were recorded at a rate of 1 mm/mm until material failure. Young's modulus, tensile strength and final elongation were calculated. (B) Dynamic mechanical analysis. First, the material was cooled down and equilibrated at −60° C. Then, the temperature was raised at 3° C./min to 70° C. The storage and the loss modulus are shown. The change of the loss factor (tan δ) is also shown. The onset temperature (Tₒₙₛₑₜ) of the storage modulus, the peak temperature (Tₚₑₐₖ) of the loss modulus, Tₚₑₐₖ of the tan δ and the temperature range of tan δ>0.3 (T_{Tan δ}>0.3) are shown.

FIG. 5 shows the thermal behavior of the inventive suberin-based elastomer. The thermal stability of the elastomer was studied under nitrogen or oxygen atmosphere. Averages and standard deviations were calculated based on data derived from individually produced material. (A) Thermogravimetric analysis under nitrogen atmosphere. The weight of the elastomer was monitored while increasing the temperature at 10° C./min to 700° C. The derivative of the weight loss is also shown (DTG). For each degradation phase the weight loss, the onset temperature (Tₒₙₛₑₜ (5%)) of the weight loss and its endset temperature (T_{endset}) is shown. (B) Differential scanning calorimetry under oxygen atmosphere. The heatflow from a sample was followed while increasing the temperature at 10° C./min from 50° C. to 500° C. For each degradation phase the onset temperature (Tₒₙₛₑₜ(5%)) is shown.

FIG. 6 shows the resistance of the claimed suberin-based elastomer to different organic solvents. Samples of the claimed elastomer with a defined weight were immersed into different organic solvents and incubated for 3 h at 65° C. Then the solvent was removed, the material dried and weight of the dried material was measured. Averages and standard deviations of the relative weight are depicted.

### DETAILED DESCRIPTION OF THE INVENTION

The invention provides an elastomeric material obtainable by a method of polymerizing suberin monomers, comprising the consecutive steps of
a) providing powdered birch bark;
b) removing extractives to obtain a fraction comprising suberin;
c) alkaline hydrolysis of the fraction comprising suberin, whereby suberin is broken down to suberin monomers;
d) acidification of the fraction comprising suberin monomers, whereby the suberin monomers are protonated hence making the suberin monomers more hydrophobic;
e) extraction of the suberin monomers, whereby the protonated suberin monomers are separated from hydrophilic compounds;
f) melting the suberin monomers; and
g) polymerizing the melted monomers,
   wherein no added catalyst is present during the polymerization, and wherein the elastomeric material obtained is cross-linked.

The absence of added catalyst shall be construed as including also absence of any added enzyme.

The fraction comprising suberin, in step b), is preferably obtained through ethanol extraction, followed by evaporation of the ethanol.

The alkaline hydrolysis in step c) is preferably carried out at a temperature of 60-90° C., e.g. 70-80° C., for a time of 1-5 hours, e.g. 2-4 hours.

In step c), after the alkaline hydrolysis, the solution comprising suberin monomers may be filtered to remove non-hydrolyzed components, i.e. lignin and carbohydrates. This filtration is not essential, but may facilitate the following processing steps, in particular the phase separation in step e).

In step d) the fraction is acidified to a pH in the interval of 2-5, preferably to a pH in the interval of 3-4.

The extraction in step e) may be carried out with a solvent chosen from the group consisting of dichloromethane, chloroform, diethyl ether, methyl tert-butyl ether, octanol, nonanol, decanol, toluene, preferably methyl tert-butyl ether, followed by evaporation. The extraction step is preferably carried out twice.

As a final part of step e) the suberin monomers may be dried. Drying may be effected through rotary evaporation.

During melting in step f) the temperature may be in the interval of 70-90° C., preferably 75-85° C.

In step f), the suberin monomers being melted constitute at least 95% of the material being melted.

### Isolation of Suberin Ionomers

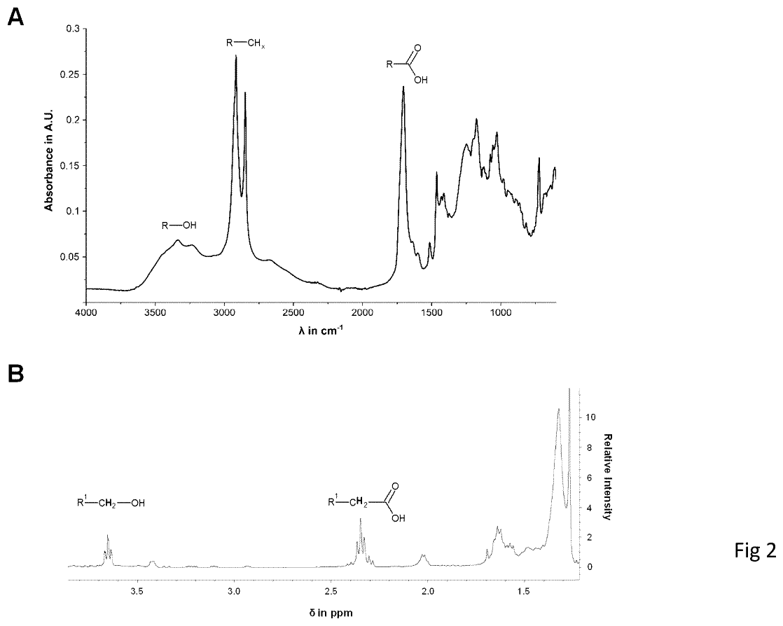

In one aspect of the invention, birch bark was milled and betulin and other triterpenoids were extracted with ethanol. The remaining residue presents a complex of suberin, lignin and carbohydrates. To release suberin monomers from this residue alkaline hydrolysis was performed in 0.5 M NaOH in ethanol/water (9:1). The suberin monomers were separated from the lignin carbohydrate complex by filtration. Then suberin monomers were protonated with 0.5 M sulfuric acid and subsequently extracted using methyl tert-butyl ether. Yields were calculated from the dry weight of all fractions and are given as relative values respective to the amount of milled bark used. For a characterization of the individual fractions by FT-IR and NMR reference is made to FIG. 2.

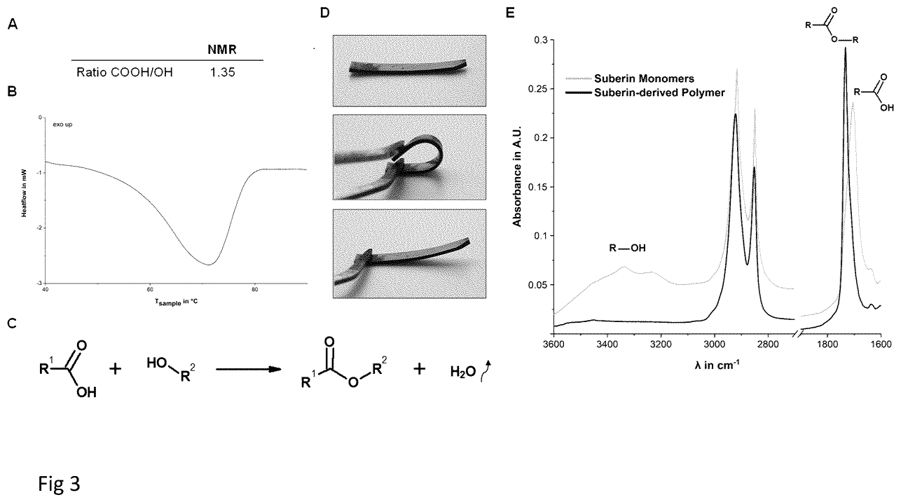

Suberin consists mainly of aliphatic compounds that contain hydroxyl and carboxylic acid groups. FT-IR and NMR spectroscopy were used to verify the presence of these functional groups in the extract (FIGS. 2(A) and (B) and FIG. 3(A)). These methods were used to define a structural “fingerprint” for the material, allowing for rapid batch-to-batch comparisons, ensuring the reproducibility of the inventive method disclosed herein. These techniques were complemented with GC-MS to identify and quantify the major compounds in the isolated suberin fraction. It was found that the suberin fraction contained monomers with a chain length of C10-C30, with C18 compounds being most abundant. Further, we found that ˜69% of suberin monomers were hydroxylated mono carboxylic acids and ˜28% of suberin monomers had two carboxylic acid groups. Specific suberin monomers were identified. Importantly, a number of identified suberin monomers had more than two functional groups thus allowing the formation of a cross-linked polymer from the isolated suberin monomers.

### Polymerization and Initial Elastomer Characterization

Differential scanning calorimetry (DSC) experiments showed that the isolated suberin monomers melt below 90° C. (FIG. 3(B)). Therefore, the suberin monomers could be melted first and then polymerized at 120° C. Use of an open system allows the water that forms during the reaction to evaporate (FIG. 3(C)). The polymerization comprised by the inventive method is heat induced and/or proceeds through polycondensation.

### Elastomeric Material Obtained

Using the inventive method, an all bio-based, highly flexible, elastomeric material was obtained (FIG. 3(D)). To monitor the formation of the polyester, FT-IR spectroscopy was used (FIG. 3(E)). We observed a complete peak shift of the carboxylic acid peak (1715 cm⁻¹) that is prevalent in the spectrum of our isolated suberin fraction towards the ester peak (1730 cm⁻¹). Further, the elastomer showed almost no absorbance in the hydroxyl vibration region (3100-3500 cm⁻¹). Together, this indicates that the vast majority of hydroxyl groups and carboxylic acid groups had reacted to form ester bonds.

### Mechanical and Thermal Properties

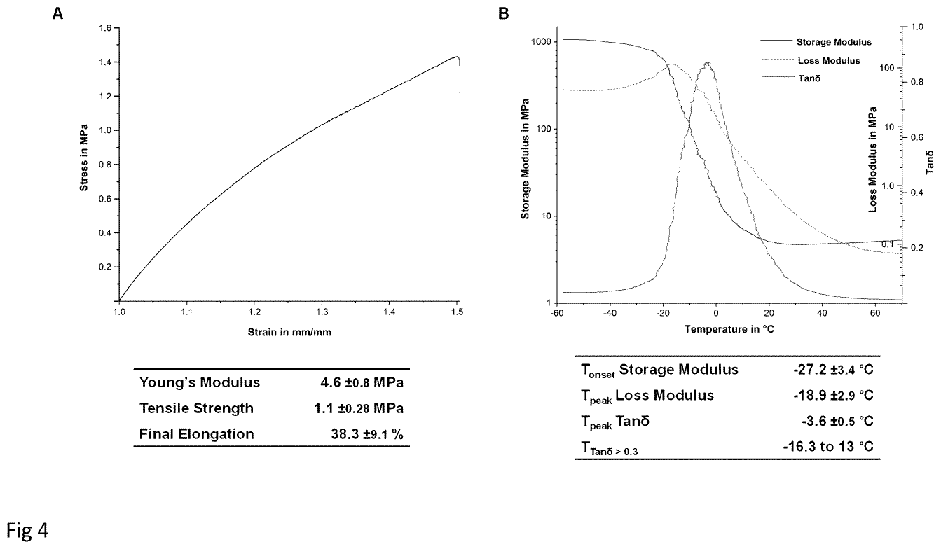

The mechanical properties of the elastomeric material were studied. Using tensile testing it was found that the elastomer showed a tensile strength of ˜1 MPa which is in the same order of magnitude as natural rubber (FIG. 4). Next, DMA was used to study the thermomechanical properties of the inventive elastomeric material. An onset temperature of the storage modulus at approximately −27° C. was observed, and the peak temperature of the loss modulus was found to be −19° C. DMA can also be used to evaluate the damping properties of a material characterized by the loss factor or tan S. Loss factors greater than 0.3 are indicative of good damping characteristics. For the inventive suberin-based elastomeric material, a loss factor greater than 0.3 was observed in a temperature range from −16° C. to 13° C., with a peak at around −3.6° C. In contrast, natural rubber is known to have a peak temperature of its loss factor around −50° C., which is not within the working range of many everyday applications. Notably, the effective damping temperature of the inventive suberin-based elastomeric material is much higher, thus making it more suitable for several applications.

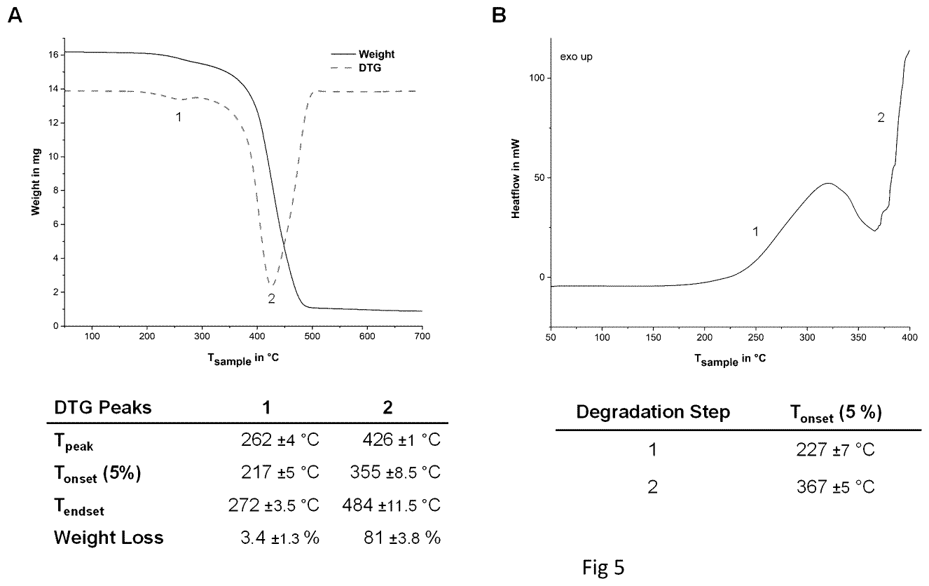

The thermal stability of the suberin-based elastomer was also monitored using TGA. The inventive material showed a two-step degradation behavior with onset temperatures of around 217° C. (DTG peak at 262° C.) for the minor degradation phase and 355° C. (DTG peak at 426° C.) for the major degradation phase (FIG. 5). Further, the thermal degradation of the inventive suberin-based elastomer yielded an ash content of approximately 8%. It is noteworthy that natural rubber is less stable than the inventive material, with a DTG peak below 400° C. for its major degradation step.

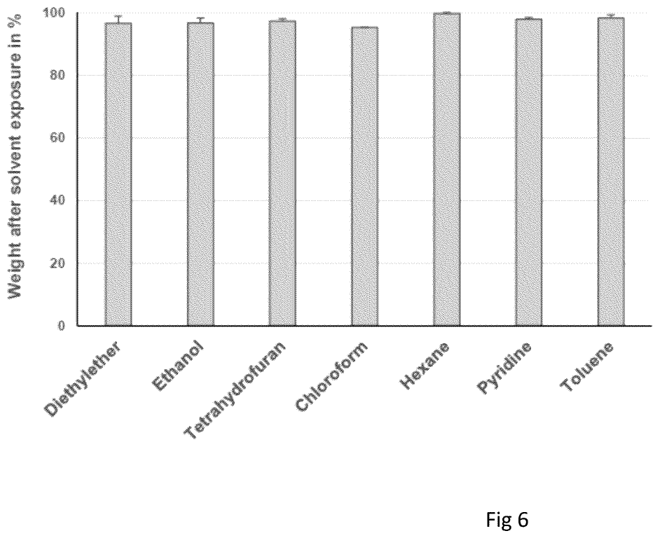

Finally, DSC was used to monitor the susceptibility of the inventive elastomer to oxidation. It was found that, in an oxygen atmosphere, the inventive material did not crystallize or melt, but starts to degrade at around 227° C. (FIG. 5). Furthermore, a second, major degradation step was observed above 367° C. Notably, these degradation temperatures are similar to the ones found in the TGA experiments conducted under a nitrogen atmosphere. Therefore, the inventive elastomer appears not to be prone to oxidation. The absence of a melting peak in the DSC experiments indicates the formation of a cross-linked elastomer, which is in line with the proposed formation of a network of suberin monomers that are connected via ester bonds. Moreover, we also observed that the elastomer as claimed is insoluble in many organic solvents, showing indeed the presence of a cross-linked polymer (FIG. 6). Taken together, the data presented shows that the inventive all bio-based elastomeric material is more stable than natural rubber and that this stability is derived from the network-like structure of the inventive elastomer.

Hence, an elastomeric material obtainable using the method described herein is claimed, characterized in that it is cross-linked. The elastomeric material is further characterized in that the suberin monomers have a carbon chain length in the interval from 10 to 30, preferably from 16 to 24. Betulin, betulinic acid and ferulic acid may be considered to be part of the suberin group of monomers. When this is the case, the suberin monomers have a carbon chain length from 10 to 30. When betulin, betulinic acid and ferulic acid are not considered to be part of the suberin group of monomers, the suberin monomers have a carbon chain length from 16 to 24.

The elastomeric material obtainable using the method described herein may have a tensile strength of 0.9-10 MPa.

The loss factor of the elastomeric material obtainable by the method disclosed herein has a maximum in the temperature range of −20° C. to 20° C., e.g. −10° C. to 10° C. The elastomeric material shows no melting peak in melting experiments using differential scanning calorimetry. The elastomeric material further shows DTG peaks at temperatures above 250° C.

### Examples

### Materials and Methods

### Materials

If not stated otherwise, chemicals were purchased from Sigma-Aldrich (Sweden). Birch bark was provided by the Johansson lab (Department of Fibre and Polymer Technology, KTH, Stockholm).

### Biorefinery of Birch Bark

Birch bark was cut and milled to a powder using a Mixer Mill MM 400 (Retsch). Extractives were separated with ethanol by performing a Soxhlet extraction for 20 h. The extractive fraction was obtained by evaporating the ethanol using a rotary evaporator and air-drying. The residue from the Soxhlet extraction was dried and then subjected to alkaline hydrolysis using 0.5 M NaOH in ethanol/water (9:1) at 75° C. for 1.5 h. Then, this mixture was filtered and the filter cake representing the lignin-carbohydrate fraction was dried. The filtered solution containing the hydrolyzed suberin monomers was acidified with 0.1 M sulphuric acid to a pH of ˜3.5. Subsequently, suberin monomers were extracted twice with methyl tert-butyl ether. Finally, the solvent was evaporated and the suberin monomers were air-dried. To monitor the mass balance, the weight of all dried isolated fractions was measured.

### Analysis of Obtained Birch Bark Components

### Fourier-Transform Infrared Spectroscopy (FT-IR)

FT-IR spectra were collected on a Perkin-Elmer Spectrum 2000 instrument (Norwalk, CT) equipped with a single-reflection attenuated total reflection accessory unit (Graseby Specac LTD). Spectra were averaged from 16 scans recorded from 4000 cm-1 to 600 cm⁻¹ at a resolution of 4 cm⁻¹.

### Nuclear Magnetic Resonance Spectroscopy (NMR)

To record H¹-NMR spectra, samples were first solubilized in either deuterated chloroform or deuterated DMSO. NMR spectra were then recorded on an AM 400 (Bruker) at 400 MHz and the residual solvent peaks were used as reference (6=7.26 for CDCl₃; δ=2.5 for D₆-DMSO).

### Preparation and Characterization of a Suberin-Based Elastomer

Melt processing of the isolated mixture of suberin monomers was tested, using differential scanning calorimetry (DSC). Approximately 30 mg of suberin monomers were transferred to a 40 μL aluminium crucible, and DSC data were recorded using a DSC-1 instrument equipped with a Gas Controller GC100 (Mettler Toledo). Samples were heated in an N₂ atmosphere from 30° C. to 100° C. with a heating rate of 1° C./min. To synthesize a suberin-based elastomer, the isolated monomer mixture was solubilized in ethanol and the solution was transferred into a polytetrafluoroethylene petri dish (Cowie Technology). Samples were incubated at 120° C. for 60 h. The elastomer was allowed to cool down to room temperature, whereupon unreacted suberin monomers were removed with ethanol. Finally, the elastomer was air-dried.

To monitor polyester formation FT-IR spectra of the elastomer were recorded as described above. The resistance of the produced elastomer to acidic and alkaline conditions was monitored by incubating samples of a defined weight (25-45 mg) in solutions with different pH values (pH 0; 4; 7; 11; 13) for 168 h at 65° C. Then, the solution was removed and each sample was washed once with water and twice with ethanol. Afterwards, samples were dried and the weight of each sample was measured to determine mass loss. To test the solubility of the produced elastomer in different organic solvents, samples of a defined weight (20-50 mg) were immersed into organic solvents and incubated for 3 h at 65° C. Then, the solvents were removed, each sample was dried and the weight of each sample was determined to monitor the weight loss. The hydrophobicity of the elastomer was assessed by monitoring its water contact angle using a CAM200 contact angle meter (KSV Instruments LTD). A 3 μL drop of MilliQ water was placed onto the sample surface and the contact angle was measured after 10 s.

### Mechanical Properties

To assess the mechanical properties of the produced suberin-based elastomer, rectangular specimens were prepared with a length to width ratio greater than 1:5. Stress-strain behaviour was monitored using an Instron 5944 with a strain rate of 0.1 mm/mm. Dynamic mechanical analysis (DMA) was performed using a Q800 (TA Instruments) in tensile mode at a frequency of 1 Hz and a strain of 0.5%. First, the specimen was cooled down to −60° C. and after 10 min the temperature was raised to 80° C. at a heating rate of 3° C./min.

### Thermal Properties

Thermal properties of the synthesized suberin-based elastomer were studied using DSC and thermogravimetric analyses (TGA). For DSC measurements approximately 5-15 mg of material was placed in a 40 μL aluminum crucible and DSC data were recorded using a DSC-1 instrument equipped with a Gas Controller GC100 (Mettler Toledo). Samples were heated in an N₂ or 02 atmosphere from 30° C. to 500° C. with a heating rate of 10° C./min. TGA was performed using a TGA851e instrument (Mettler Toledo). Up to 20 mg of the produced elastomer was placed in an aluminium pan and the sample was heated from 30° C. to 650° C. with a heating rate of 10° C./min under a nitrogen gas atmosphere and the weight loss was recorded. The data were analyzed using the STARe Excellence software (Mettler Toledo).

1. An elastomeric material obtainable by a method of polymerizing suberin monomers, comprising the consecutive steps of
a) providing powdered birch bark;
b) removing extractives to obtain a fraction comprising suberin;
c) conducting alkaline hydrolysis of the fraction comprising suberin, whereby suberin is broken down to suberin monomers;
d) conducting acidification of the fraction comprising suberin monomers;
e) conducting extraction of the suberin monomers;
f) melting the suberin monomers; and
g) polymerizing the melted monomers,
wherein no added catalyst is present during the polymerization, and wherein the elastomeric material obtained is cross-linked.

2. The elastomeric material according to claim 1, wherein in step b) the fraction comprising suberin was obtained after ethanol extraction, followed by evaporation of the ethanol.

3. The elastomeric material according to claim 1, wherein in step c) the alkaline hydrolysis is carried out at a temperature of 60-90° C., for a time of 1-5 hours.

4. The elastomeric material according to claim 1, wherein in step c) in a preceding step after the alkaline hydrolysis, the solution comprising suberin monomers is filtered to remove non-hydrolysed components.

5. The elastomeric material according to claim 1, wherein in step d) the fraction is acidified to a pH in the interval of 2-5.

6. The elastomeric material according to claim 1, wherein in step e) extraction is carried out with a solvent chosen from the group consisting of dichloromethane, chloroform, diethylether, methyl tert-butyl ether, octanol, nonanol, decanol, and toluene, followed by evaporation.

7. The elastomeric material according to claim 1, wherein in step e) the suberin monomers are dried.

8. The elastomeric material according to claim 1, wherein in step f) the temperature is in the interval of 70-90° C.

9. The elastomeric material according to claim 1, wherein the polymerization is heat induced and/or proceeds through polycondensation.

10. The elastomeric material according to claim 1, wherein the suberin monomers have a carbon chain length in the interval from 10 to 30.

11. The elastomeric material according to claim 1, wherein the elastomeric material has a tensile strength of 0.9-10 MPa.

12. The elastomeric material according to claim 1, wherein the elastomeric material has a loss factor having a maximum in the temperature range of −20° C. to 20° C.

13. The elastomeric material according to claim 1, wherein the elastomeric material shows no melting peak in melting experiments using differential scanning calorimetry.

14. The elastomeric material according to claim 1, wherein the elastomeric material shows DTG peaks at temperatures above 250° C.
